(19) United States
(12) Patent Application Publication
(10) Pub. No.: US 2006/0120061 A1
(43) Pub. Date: Jun. 8, 2006

(54) Backlight assembly and liquid crystal display device having the same

(76) Inventors: Hyeon-Yong Jang, Osan-si (KR); Cheol-Jin Park, Suwon-si (KR)

Correspondence Address: CANTOR COLBURN, LLP, 55 GRIFFIN ROAD SOUTH, BLOOMFIELD, CT, 06002, US

(21) Appl. No.: 11/289,223

(22) Filed: Nov. 28, 2005

(30) Foreign Application Priority Data
Dec. 8, 2004 (KR) 2004-102929

(51) Int. Cl. G01D 11/28

(52) U.S. Cl. 362/27; 362/612; 362/614

(57) ABSTRACT

In a backlight assembly and an LCD device having the same, a backlight assembly includes a main light source and an auxiliary light source. The main light source is under an LCD panel that displays an image. The main light source generates a main light. The auxiliary light source generates an auxiliary light. Therefore, luminance of the backlight assembly becomes more uniform, and an image display quality of the LCD device is improved.

The present application claims priority to Korean Patent Application No. 2004-102929, filed on Dec. 8, 2004, the contents of which are incorporated herein by reference in its entirety.

### BACKGROUND OF THE INVENTION

1. Field of the Invention

The present invention relates to a backlight assembly and a liquid crystal display (LCD) device having the backlight assembly. More particularly, the present invention relates to a backlight assembly capable of providing uniform luminance and an LCD device having the backlight assembly.

2. Description of the Related Art

An LCD device displays images using liquid crystal that has optical characteristics such as anisotropy of refractivity and electrical characteristics such as anisotropy of dielectric constant. The LCD device has advantageous characteristics such as lower thickness, lower driving voltage, lower power consumption, or the like, when compared with other display devices such as cathode ray tube (CRT) devices, plasma display panel (PDP) devices, or the like. Therefore, the LCD device is widely used in devices such as a notebook computer, a computer monitor, a television receiver set, or the like.

The LCD device is a non-emissive type display device that requires a backlight assembly to supply an LCD panel of the LCD device with a light.

The backlight assembly includes a light source to generate the light. The backlight assembly includes a cold cathode fluorescent lamp (CCFL), a light emitting diode (LED), or the like, as the light source. The backlight assembly is classified as either being an edge illumination type or a direct illumination type based on a location of the light source. In the edge illumination type, the backlight assembly includes a light guiding plate and one or two light sources adjacent to a side surface of the light guiding plate so that the light generated from the light sources is guided into an LCD panel of the LCD device. In the direct illumination type, the backlight assembly includes a plurality of light sources disposed under the LCD panel and a diffusion plate between the LCD panel and the light sources so that the light generated from the light sources is diffused and irradiated onto the LCD panel.

A large-screen LCD device has large-sized direct illumination type backlight assembly.

When the size of the backlight assembly is increased, a luminance from corners of the backlight assembly is lower than that of a central portion of the backlight assembly so that the uniformity of the light generated from the backlight assembly is deteriorated, thereby deteriorating the image display quality of the LCD device.

### SUMMARY OF THE INVENTION

The present invention provides a backlight assembly capable of providing uniform luminance.

The present invention also provides an LCD device having the above-mentioned backlight assembly.

A backlight assembly in accordance with an exemplary embodiment of the present invention includes a main light source and an auxiliary light source. The main light source is under an LCD panel that displays an image. The main light source generates a main light. The auxiliary light source is disposed under the LCD panel. The auxiliary light source generates an auxiliary light.

An LCD device in accordance with an aspect of the present invention includes a backlight assembly and an LCD panel. The backlight assembly includes a main light source and an auxiliary light source that generates a light. The LCD panel displays an image using the light generated from the backlight assembly.

According to the present invention, luminance of a light generated from the corners of the backlight assembly is increased to provide uniform luminance of the backlight assembly, thereby improving image display quality.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exemplary exploded perspective view showing a backlight assembly in accordance with the present invention;

FIG. 2 is an exemplary plan view showing a backlight assembly shown in FIG. 1;

FIG. 3 is an exemplary perspective view showing a main light source of the backlight assembly shown in FIG. 1;

FIG. 4 is a cross-sectional view taken along line I-I′ shown in FIG. 3;

FIG. 5 is an exemplary perspective view showing another main light source of the backlight assembly shown in FIG. 1;

FIG. 6 is an exemplary perspective view showing still another main light source of the backlight assembly shown in FIG. 1;

FIG. 7 is an exemplary plan view showing a method of driving the backlight assembly shown in FIG. 1;

FIG. 8 is an exemplary plan view showing another method of driving the backlight assembly shown in FIG. 1;

FIG. 9 is an exemplary plan view showing still another method of driving the backlight assembly shown in FIG. 1; and

FIG. 10 is an exemplary exploded perspective view showing a liquid crystal display (LCD) device in accordance with the present invention.

### DETAILED DESCRIPTION OF THE INVENTION

It should be understood that the exemplary embodiments of the present invention described below may be varied or modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

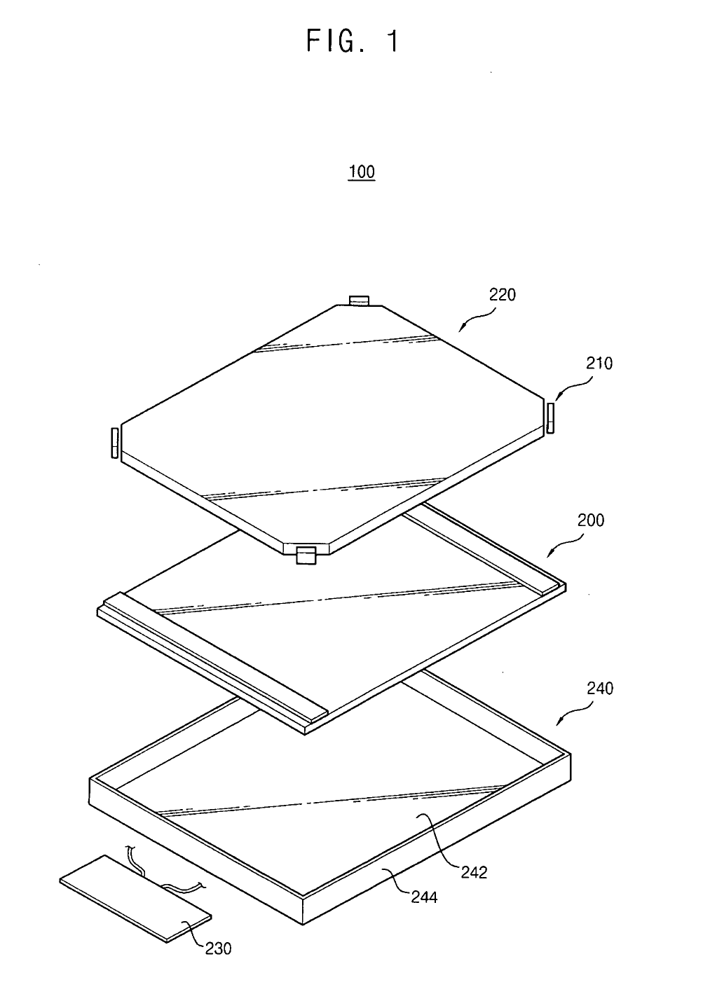

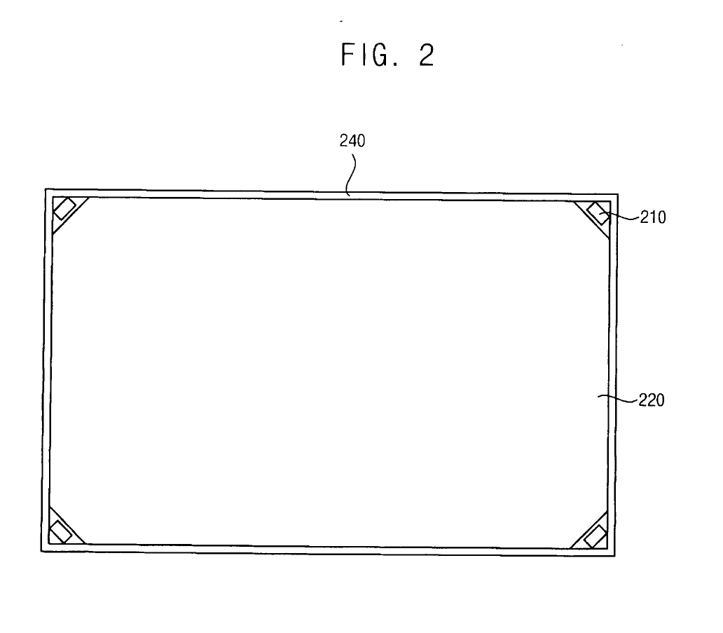

FIG. 1 is an exemplary exploded perspective view showing a backlight assembly in accordance with the present invention. FIG. 2 is a plan view showing a backlight assembly shown in FIG. 1.

Referring to FIGS. 1 and 2, the backlight assembly 100 includes a main light source 200 and a plurality of auxiliary light sources 210.

The main light source 200 is under an LCD panel (not shown), and supplies the LCD panel (not shown) with the main light. In this exemplary embodiment, the main light source 200 is under a central portion of the LCD panel (not shown). The main light source 200 may include a flat fluorescent lamp (FEL), a plurality of cold cathode fluorescent lamps (CCFLs), a plurality of external electrode fluorescent lamps (EEFLs), or the like. The luminance at the corners of the main light source 200 is lower than that of the central portion of the main light source 200.

The auxiliary light sources 210 are adjacent to the corners of the main light source 200 to generate auxiliary light that compensates for the lower amount of main light at the corners. The auxiliary light sources 210 are on outside of an active area that corresponds to the main light source 200. As noted above, the auxiliary light sources 210 compensates for the lower amount of luminance at the corners of the main light source 200 to provide uniform luminance of the backlight assembly 100. In this exemplary embodiment, each of the auxiliary light sources 210 is a light emitting diode (LED) that generates a white light. The LED has advantageous characteristics such as small size, low price, simplified driving method, or the like.

The backlight assembly 100 further includes a diffusion plate 220 on the main light source 200. The diffusion plate 220 diffuses the main light generated from the main light source 200 so that the luminance of the main light is uniformly provided. In addition, the diffusion plate 220 may also diffuse the auxiliary light. The diffusion plate 220 has, for example, a quadrangular plate-like shape that has a predetermined thickness. The diffusion plate 220 is spaced at a constant distance from the main light source 220. In this exemplary embodiment, the diffusion plate 220 has polymethyl methacrylate (PMMA) and a diffusing agent.

In this exemplary embodiment, the auxiliary light sources 210 are disposed so as to be adjacent to the corners of the diffusion plate 220. The corners of the diffusion plate 220 are chamfered so that the auxiliary light sources 210 are adjacent to the chamfered corners. The luminance of the corners of the diffusion plate 220 is therefore increased by the auxiliary light sources 210. Alternatively, the auxiliary light sources 210 may be disposed adjacent to corners of the main light source 200 or between each of the corners of the diffusion plate 220 and each of the corners of the main light source 200.

The backlight assembly 100 further includes an inverter 230 that supplies electric power to the main light source 200. The inverter 230 functions as a transformer to increase the level of the externally provided electric power. The inverter 230 also supplies the electric power to the auxiliary light sources 210. In this exemplary embodiment, the inverter 230 independently applies the electric power to the main light source 200 and the auxiliary light source 210. Alternatively, the inverter 230 may simultaneously apply the electric power to the main light source 200 and the auxiliary light source 210. In other words, the inverter 230 serves as a single source of power to the main light source as well as the auxiliary light source 210.

The backlight assembly 100 further includes a receiving container 240. The receiving container 240 includes a bottom plate 242 and a plurality of sidewalls 244 that protrude from the edges of the bottom plate 242 to form a receiving space. The main light source 200, the auxiliary light sources 210 and the diffusion plate 220 is located in the receiving space. The receiving container 240 is manufactured from a strong metal or from a carbon fiber based composite that may not be easily deformed.

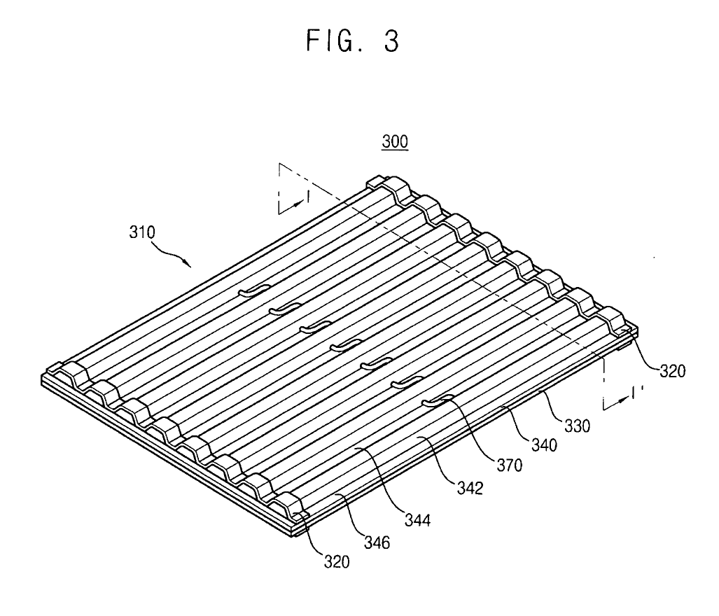

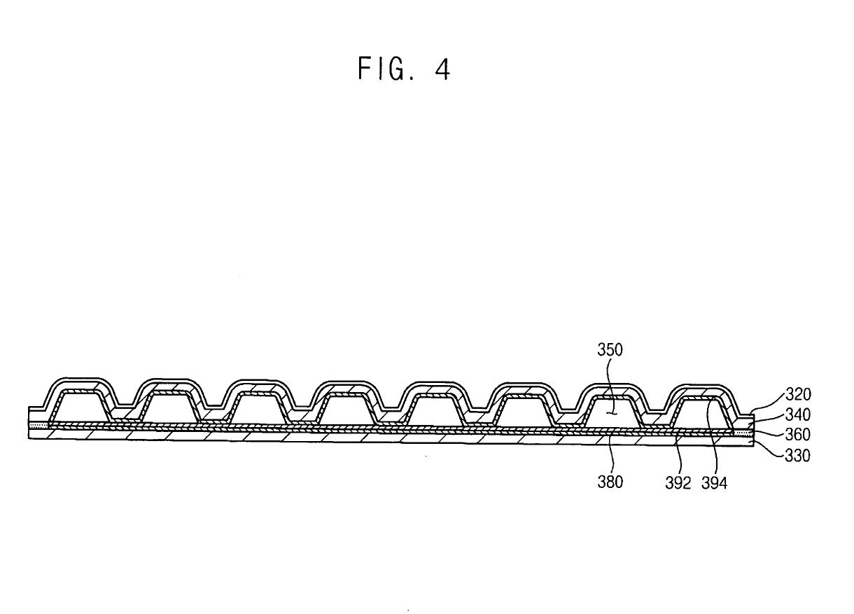

FIG. 3 is an exemplary perspective view showing a main light source of the backlight assembly shown in FIG. 1. FIG. 4 is a cross-sectional view taken along line I-I′ shown in FIG. 3. The main light source is a flat fluorescent lamp (FFL).

Referring to FIGS. 3 and 4, the FFL 300 includes a lamp body 310 and an electrode 320 on an outer surface of the lamp body 310.

The lamp body 310 includes a first substrate 330 and a second substrate 340 that is combined with the first substrate 330 to form a plurality of discharge spaces 350.

The first substrate 330 has a quadrangular plate-like shape. In this exemplary embodiment, the first substrate 330 has a transparent glass substrate. The first substrate 330 blocks ultraviolet light.

The second substrate 340 includes a plurality of discharge space portions 342, a plurality of space dividing portions 344 and a sealing portion 346. The discharge space portions 342 are spaced apart from the first substrate 100 to form the discharge spaces 350. The space dividing portions 344 are between the discharge space portions 342, and make contact with the first substrate 100. That is, each of the space dividing portions 344 is formed between the discharge space portions 342 adjacent to each other to form each of the discharge spaces 350. In this exemplary embodiment, the second substrate 340 is a transparent glass substrate that has a substantially same material as the first substrate 330. The second substrate 340 also blocks the ultraviolet light.

The second substrate 340 is formed through a molding process. That is, a glass plate is heated and pressed to form the second substrate 340 having the discharge space portions 342, the space dividing portions 344 and the sealing portion 346. Alternatively, the second substrate 340 may be formed through a blow molding process. In the blow molding process, the glass plate is heated and compressed by air to form the second substrate 340.

A cross-section of the second substrate 340 includes a plurality of trapezoidal shapes that are connected to one another. The trapezoidal shapes have rounded corners, and the edges of the successive trapezoidal shapes are arranged to be substantially in parallel with one another. Alternatively, the cross-section of the second substrate 340 may have a semicircular shape, a quadrangular shape, a polygonal shape, or the like.

The second substrate 340 further includes connecting passages 370. Each of the connecting passages 370 connects the discharge spaces 350 adjacent to each other. At least one connecting passage 370 is formed on each of the space dividing portions 344. The discharge gas that is injected into one of the discharge spaces 350 may pass through the connecting passage 370 so that pressure in the respective discharge spaces 350 is substantially equal to one another. In other words, there is a uniform pressure across all the discharge spaces 350. The connecting passages 370 may be formed via a molding process for forming the second substrate 340. Each of the connecting passages 370 may have various shapes. In this exemplary embodiment, each of the connecting passages 370 may have an S shape.

The second substrate 340 is combined with the first substrate 330 using an adhesive 360. In this exemplary embodiment, a frit is interposed as an adhesive between the first and second substrates 330 and 340 to combine the first substrate 330 with the second substrate 340. The frit is a mixture of glass and metal, and the melting point of the frit is lower than that for pure glass. That is, the adhesive 360 is prepared on peripheral portions of the first and second substrates 330 and 340, and the adhesive 360 is fired and solidified, thereby fixing the first substrate 330 with the second substrate 340.

The lamp body 310 further includes a reflecting layer 380, a first fluorescent layer 392 and a second fluorescent layer 394. The reflecting layer 380 is disposed on an upper surface of the first substrate 330. The first fluorescent layer 392 is disposed on the reflecting layer 380. The second fluorescent layer 394 is disposed on a lower surface of the second substrate 340. A portion of a visible light that is generated from the first and second fluorescent layers 392 and 394 is reflected from the reflecting layer 380 toward the second substrate 340 to prevent a light leakage of the visible light through the first substrate 330. The reflecting layer 380 may comprise a metal, a metal oxide, or the like, or a combination comprising at least one of the foregoing. In this exemplary embodiment, the reflecting layer 380 includes aluminum oxide (Al₂O₃), barium sulfate (BaSO₄), or the like. When ultraviolet light generated by a plasma discharge is irradiated onto the first and second fluorescent layers 392 and 394, excitons are generated in the first and second fluorescent layers 392 and 394. When the energy level of the excitons decreases, the first and second fluorescent layers 392 and 394 emit visible light. In this exemplary embodiment, the reflecting layer 380 and the first fluorescent layer 392 are coated on the upper surface of the first substrate 330 except between the first substrate 330 and the sealing portion 346, and the second fluorescent layer 394 is coated on the lower surface of the second substrate 340 except the sealing portion 346. Alternatively, the reflecting layer 380 and the first and second fluorescent layers 392 and 394 may not be formed between the first substrate 330 and the space dividing portions 344.

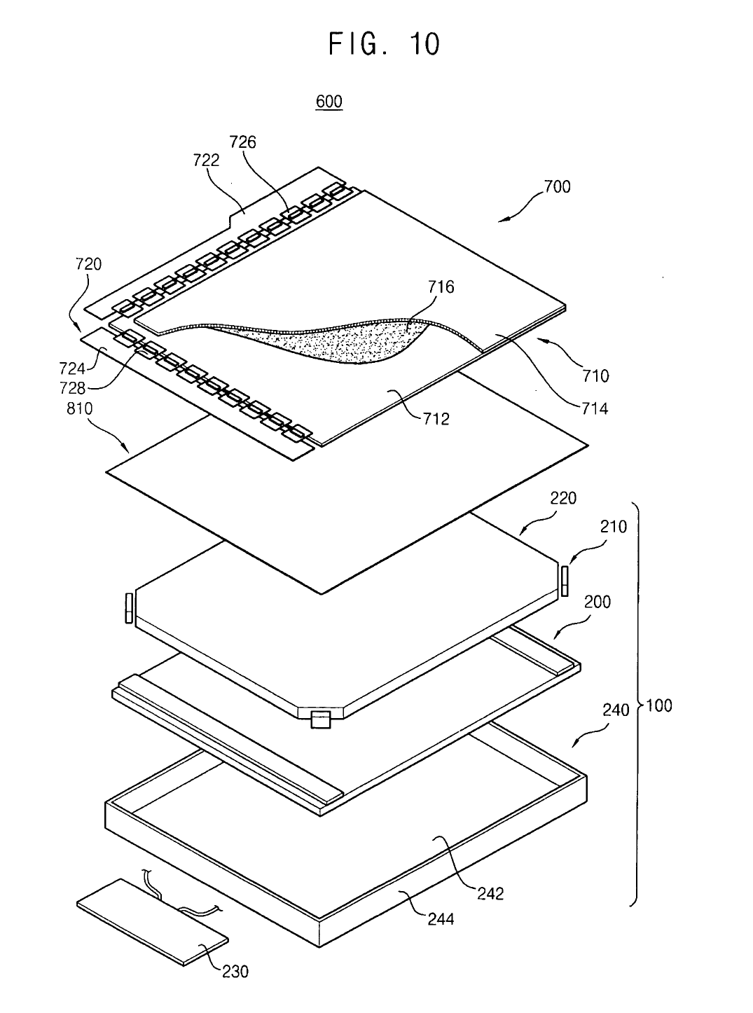

The electrode 320 is disposed on the second substrate 340, and traverses the discharge spaces 350. In this exemplary embodiment, two electrodes 320 are disposed on opposite end portions of the second substrate 200 to be overlapped with end portions of the discharge spaces 350. Each of the electrodes 320 comprises a conductive material so that the inverter applies the electric power to the lamp body 310 through the electrodes 320. For example, a silver paste that is a mixture of silver and silicon oxide is coated on the lamp body 310 to form the electrodes 320. A metal power comprising copper, nickel, silver, gold, aluminum, chromium, or the like, may be coated on the lamp 310 to form the electrodes 320. Alternatively, the electrodes 320 may be formed on the first substrate 330. When the electrodes 320 are formed on the first and second substrates 330 and 340, each of the electrodes 320 on the first substrate 330 and each of the electrodes 320 on the second substrate 340 are electrically connected to each other through a conductive clip. Alternatively, the electrodes 320 may be formed in the lamp body 310. In this exemplary embodiment, a light emitting area of the FFL 300 is substantially equal to an area of the liquid crystal display panel (referring to FIG. 10).

In this exemplary embodiment, the second substrate is molded to form the discharge spaces. Alternatively, each of the first and second substrates has a plate-like shape, and a plurality of partition walls may be interposed between the first and second substrates to form the discharge spaces.

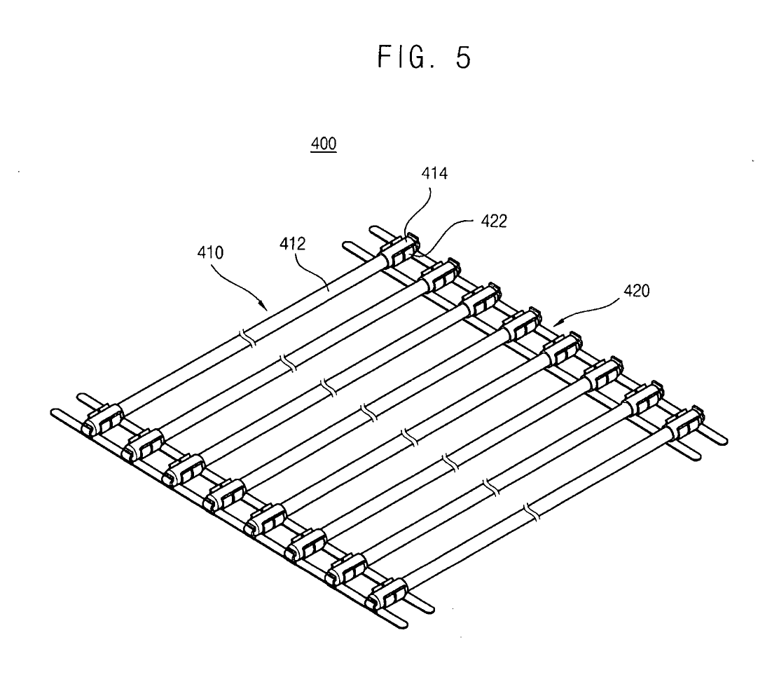

FIG. 5 is an exemplary perspective view showing another exemplary main light source of the backlight assembly shown in FIG. 1.

Referring to FIG. 5, the main light source 400 includes a plurality of external electrode fluorescent lamps (EEFLs) 410 and lamp supporters 420. The EEFLs 410 are electrically connected to one another in parallel. In this exemplary embodiment, the main light source 400 includes a plurality of lamp supporters 420. The lamp supporters 420 fixedly support the EEFLs 410.

Each of the EEFLs 410 includes a lamp body 412 and an external electrode 414. In this embodiment, the external electrode is disposed on an outer surface at an end portion of the lamp body 412. The lamp body 412 has an extended cylindrical shape. The lamp body 412 has a transparent glass. A discharge gas is injected in the lamp body 412 to generate a discharge in the lamp body 412 upon the application of a voltage to the terminals of the lamp. In this exemplary embodiment, the discharge gas includes mercury, neon, argon, or the like. In this exemplary embodiment, two external electrodes 414 are formed on opposite end portions of the lamp body 412. Each of the external electrodes 414 comprises a conductive material so that an inverter can supply an electric power to the lamp body 412 through the external electrodes 414. For example, each of the external electrodes 414 has metal or metal alloy.

In this exemplary embodiment, each of the external electrodes 414 has a sleeve shape or a socket shape that surrounds each of the end portions of the lamp body 412. In one embodiment, the socket shape surrounds only a portion of the end portion of the lamp body 412. In another embodiment, the socket shape completely surrounds the end portion of the lamp body 412. The function of the socket is to maintain the lamp body 412 in position. Each of the external electrodes 414 is combined with the lamp body 412 using a conductive adhesive such as the silver paste. Alternatively, the metal may be plated on the lamp body 412 to form the external electrodes 414. Suitable methods for plating the lamp body 412 are chemical vapor deposition (CVD), sputtering, plasma enhanced chemical vapor deposition (PECVD), expanding thermal plasma (ETP), ion plating, metal organic chemical vapor deposition (MOCVD) (also called Organometallic Chemical Vapor Deposition (OMCVD)), metal organic vapor phase epitaxy (MOVPE), physical vapor deposition processes such as sputtering, reactive electron beam (e-beam) deposition, and plasma spray. In one embodiment, the lamp body 412 may be dipped into a melted conductive material to form the external electrodes 414.

The lamp supporters 420 fixedly support the end portions of the EEFLs 410. Each of the lamp supporters 420 has a plurality of clip portions 422. Alternatively, each of the lamp supporters may have a single clip portion. The external electrodes 414 of the EEFLs 410 are inserted into the clip portions 422. Each of the lamp supporters 420 is comprised of a metal so that the inverter can supply electric power to the external electrodes 414 through the clip portions 422. Therefore, the electric power generated from the inverter is supplied to the external electrodes 414 of the EEFLs 410 through the lamp supporters 420, in parallel.

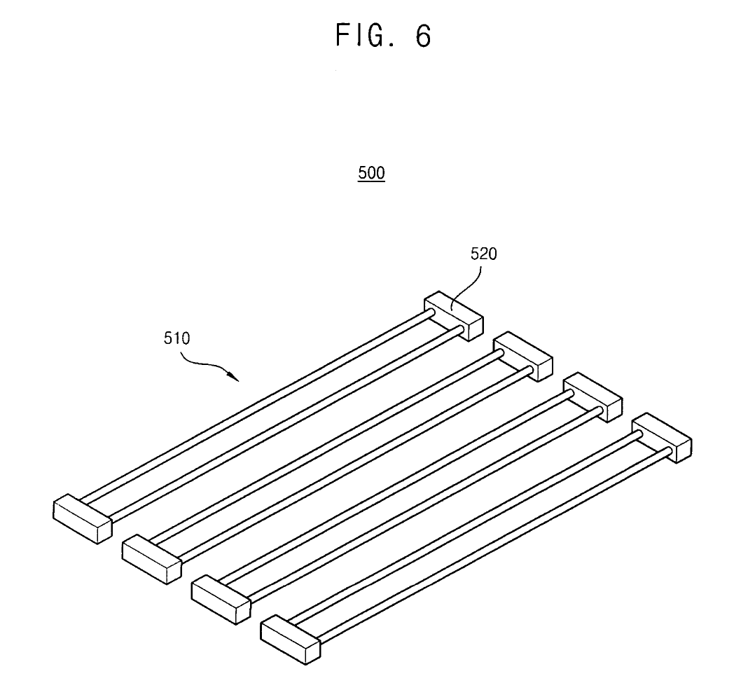

FIG. 6 is an exemplary perspective view showing still another exemplary main light source of the backlight assembly shown in FIG. 1.

Referring to FIG. 6, the main light source 500 includes a plurality of cold cathode fluorescent lamps (CCFLs) 510 that are arranged to be substantially in parallel with one another.

Each of the CCFLs 510 generates light based on an electric power applied to an internal electrode of the CCFL 510. Each of the CCFLs 510 has an extended cylindrical shape. Each of the CCFLs 510 comprises a transparent glass. A discharge gas is injected into the CCFLs 510. The CCFLs 510 are spaced apart from one another by a constant distance so that a uniform luminance of the main light source 500 is achieved. The number of the CCFLs 510 varies based on the luminance of the main light source 500.

In this exemplary embodiment, the main light source 500 may further include a plurality of lamp holders 520 to fixedly support the CCFLs 510. End portions of the CCFLs 510 are inserted into the lamp holders 520. For example, each of the lamp holders 520 receives end portions of two adjacent CCFLs 510.

FIG. 7 is a plan view showing an exemplary method of driving the backlight assembly shown in FIG. 1.

Referring to FIG. 7, the main light source 200 includes a flat fluorescent lamp having a lamp body 310 and first and second electrodes 322 and 324. Auxiliary light sources 210 include first, second, third and fourth light emitting diodes (LEDs) 212, 214, 216 and 218 adjacent to corners of the main light source 200. The first, second, third and fourth LEDs 212, 214, 216 and 218 generate white light.

The inverter 230 supplies electric power in the form of an alternating current to the main light source 200 to drive the main light source 200. In this exemplary embodiment, the main light source 200 is operated through a constant current driving method. For example, a constant current of about 100 mA (milliamperes) is applied to the main light source 200. The first, second, third and fourth LEDs 212, 214, 216 and 218 are also operated through the constant current driving method so that the first, second, third and fourth LEDs 212, 214, 216 and 218 may be electrically connected between the inverter 230 and the main light source 200. For example, a constant current of about 20 mA (milliamperes) to about 50 mA is applied to the first, second, third and fourth LEDs 212, 214, 216 and 218. In this exemplary embodiment, half wave of the alternating current is applied to the first, second, third and fourth LEDs 212, 214, 216 and 218 so that two of the first, second, third and fourth LEDs 212, 214, 216 and 218 are electrically connected to remaining two of the first, second, third and fourth LEDs 212, 214, 216 and 218 in parallel with respect to the inverter 230. That is, the inverter 230 applies the alternating current to the first electrode 322 through the first and second LEDs 212 and 214 that are electrically connected in parallel. In addition, the inverter 230 also applies the alternating current to the second electrode 324 through the third and fourth LEDs 216 and 218 that are electrically connected in parallel. The first and second LEDs 212 and 214 are forwardly connected between the inverter 230 and the first electrode 322, and the third and fourth LEDs 216 and 218 are forwardly connected between the inverter 230 and the second electrode 324. The first, second, third and fourth LEDs 212, 214, 216 and 218 are forwardly connected between the inverter 230 and the main light source 200 so that any additional driving circuitry may be omitted. That is, the first, second, third and fourth LEDs 212, 214, 216 and 218 function as a driving circuit of the main light source 200.

Alternatively, the main light source 200 having the EEFLs or the CCFLs may be operated through a constant current driving method, and the auxiliary light sources 210 are electrically connected between the inverter 230 and the main light source 200. The number of the auxiliary light sources 210 that are electrically connected between the main light source 200 and the inverter 230 may vary based on an amount of a driving current that flows through the main light source 200 and the auxiliary light sources 210.

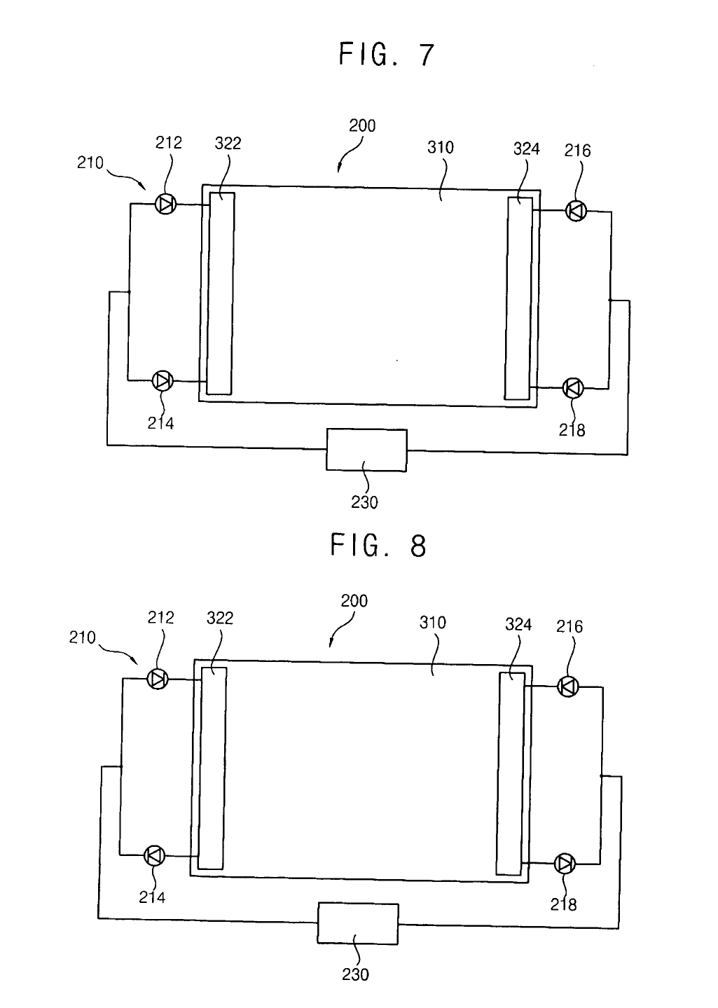

FIG. 8 is a plan view showing another exemplary method of driving the backlight assembly shown in FIG. 1.

Referring to FIG. 8, a main light source 200 includes a flat fluorescent lamp having a lamp body 310 and first and second electrodes 322 and 324. Auxiliary light sources 210 include first, second, third and fourth LEDs 212, 214, 216 and 218 adjacent to corners of the main light source 200. The first, second, third and fourth LEDs 212, 214, 216 and 218 generate white light.

An inverter 230 supplies an electric power in the form of an alternating current to the main light source 200 to drive the main light source 200. In this exemplary embodiment, the main light source 200 is operated through a constant current driving method. For example, a constant current of about 100 mA is applied to the main light source 200. The first, second, third and fourth LEDs 212, 214, 216 and 218 are also operated through the constant current driving method so that the first, second, third and fourth LEDs 212, 214, 216 and 218 may be electrically connected between the inverter 230 and the main light source 200. For example, a constant current of about 20 mA to about 50 mA is applied to the first, second, third and fourth LEDs 212, 214, 216 and 218. In this exemplary embodiment, the inverter 230 is electrically connected between two of the first, second, third and fourth LEDs 212, 214, 216 and 218 and remaining two of the first, second, third and fourth LEDs 212, 214, 216 and 218. That is, the inverter 230 supplies the alternating current to the first electrode 322 through the first and second LEDs 212 and 214 that are electrically connected in parallel. In addition, the inverter 230 also supplies the alternating current to the second electrode 324 through the third and fourth LEDs 216 and 218 that are electrically connected in parallel. The first LED 212 is forwardly connected between the inverter 230 and the first electrode 322, and the third LED 216 is forwardly connected between the inverter 230 and the second electrode 324. In addition, the second LED is inversely connected between the inverter 230 and the first electrode 322, and the fourth LED 218 is inversely connected between the inverter 230 and the second electrode 324. A portion of the electric power outputted from a first end portion of the inverter 230 is applied to a second end portion of the inverter 230 through the first LED 212, the main light source 200 and the fourth LED 218. In addition, a portion of the electric power outputted from the second end portion of the inverter 230 is applied to the first end portion of the inverter 230 through the third LED 216, the main light source 200 and the second LED 214. When the first, second, third and fourth LEDs 212, 214, 216 and 218 are forwardly connected between the main light source 200 and the inverter 230, the first, second, third and fourth LEDs 212, 214, 216 and 218 may malfunction by a portion of the electric current that flows in the inverse direction. According to this exemplary embodiment, the second and fourth LEDs 214 and 218 are inversely connected between the inverter 230 and the main light source 200 to form a flow path for the electric current that flows in the inverse direction, thereby preventing the malfunction of the first, second, third and fourth LEDs 212, 214, 216 and 218.

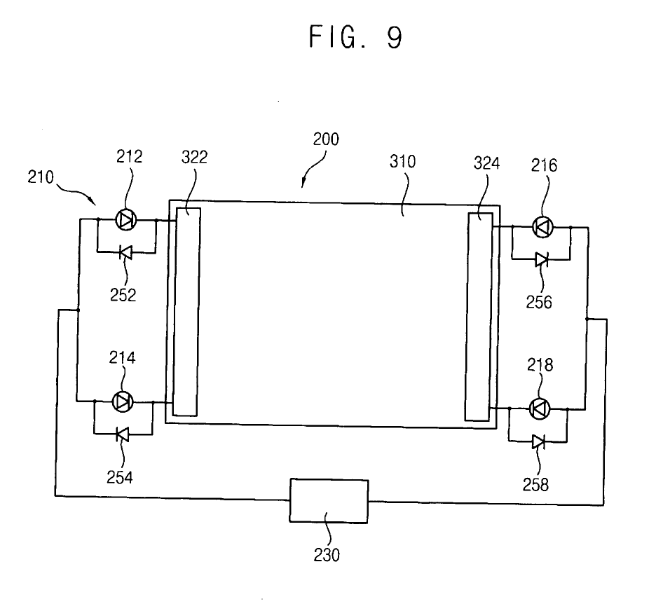

FIG. 9 is a plan view showing still another exemplary method of driving the backlight assembly shown in FIG. 1.

Referring to FIG. 9, a main light source 200 includes a flat fluorescent lamp having a lamp body 310 and first and second electrodes 322 and 324. Auxiliary light sources 210 include first, second, third and fourth LEDs 212, 214, 216 and 218 adjacent to corners of the main light source 200. The first, second, third and fourth LEDs 212, 214, 216 and 218 generate white light. In this exemplary embodiment, the backlight assembly further includes first, second, third and fourth diodes 252, 254, 256 and 258. The first diode 252 is connected in parallel to the first LED 212. The second diode 254 is connected in parallel to the second LED 214. The third diode 256 is connected in parallel to the third LED 216. The fourth diode 258 is connected in parallel to the fourth LED 218.

An inverter 230 supplies an electric power in the form of an alternating current to the main light source 200 to drive the main light source 200. In this exemplary embodiment, the main light source 200 is operated through a constant current driving method. For example, a constant current of about 100 mA is applied to the main light source 200. The first, second, third and fourth LEDs 212, 214, 216 and 218 are also operated through the constant current driving method so that the first, second, third and fourth LEDs 212, 214, 216 and 218 may be electrically connected between the inverter 230 and the main light source 200. For example, a constant current of about 20 mA to about 50 mA is applied to the first, second, third and fourth LEDs 212, 214, 216 and 218. In this exemplary embodiment, two of the first, second, third and fourth LEDs 212, 214, 216 and 218 are electrically connected to the remaining two of the first, second, third and fourth LEDs 212, 214, 216 and 218 which are connected in parallel with respect to the inverter 230. The first and second LEDs 212 and 214 are forwardly connected between the inverter 230 and the first electrode 322, and the third and fourth LEDs 216 and 218 are forwardly connected between the inverter 230 and the second electrode 324. The first and second diodes 252 and 254 are inversely connected between the inverter 230 and the first electrode 322, and the third and fourth diodes 256 and 258 are inversely connected between the inverter 230 and the second electrode 324. A portion of the electric power outputted from a first end portion of the inverter 230 is applied to a second end portion of the inverter 230 through the first and second LEDs 212 and 214, the main light source 200 and the third and fourth diodes 256 and 258. In addition, a portion of the electric power outputted from the second end portion of the inverter 230 is applied to the first end portion of the inverter 230 through the third and fourth LEDs 216 and 218, the main light source 200 and the first and second diodes 252 and 254. According to this exemplary embodiment, the first, second, third and fourth LEDs 212, 214, 216 and 218 are inversely connected to the first, second, third and fourth diodes 252, 254, 256 and 258, respectively, to decrease a malfunction of the first, second, third and fourth LEDs 212, 214, 216 and 218.

FIG. 10 is an exploded perspective view showing an LCD device in accordance with an exemplary embodiment of the present invention. The backlight assembly of FIG. 10 is same as in FIGS. 1 to 9. Thus, the same reference numerals will be used to refer to the same or like parts as those described in FIGS. 1 to 9 and any further explanation will be omitted.

Referring to FIG. 10, the LCD device 600 includes the backlight assembly 100 and a display unit 700. The backlight assembly 100 supplies the display unit 700 with light.

The display unit 700 includes an LCD panel 710 and a driving circuit member 720. The LCD panel 710 displays an image using the light generated from the backlight assembly 100. The driving circuit member 720 applies driving signals to the LCD panel 710.

The LCD panel 710 includes a thin film transistor (TFT) substrate 712, a color filter substrate 714 corresponding to the TFT substrate 712 and a liquid crystal layer 716 interposed between the TFT substrate 712 and the color filter substrate 714.

The TFT substrate 712 includes a glass substrate and a plurality of TFTs (not shown) arranged in a matrix shape. A source electrode of each of the TFTs is electrically connected to one of the data lines on the glass substrate, and a gate electrode of each of the TFTs is electrically connected to one of the gate lines on the glass substrate. A drain electrode of each of the TFTs is electrically connected to a pixel electrode (not shown) on the glass substrate.

The color filter substrate 714 includes red (R), green (G) and blue (B) color filters (not shown) that are thin films. In addition, the color filter substrate 714 further includes a common electrode (not shown) on the RGB color filters (not shown). The common electrode (not shown) is a transparent electrode.

When the electric power is applied to the gate electrode on one of the TFTs, the TFT is turned on so that an electric field is formed between the pixel electrode (not shown) and the common electrode (not shown). A liquid crystal in the liquid crystal layer 716 undergoes a rearrangement in response to the electric field applied thereto, and this results in a change in the light transmission. This change in the light transmission upon the application of an electric field between pixel and common electrodes can be used to produce and to change images on the LCD panel 710.

The driving circuit member 720 includes a data printed circuit board (PCB) 722, a gate PCB 724, a data flexible circuit film 726 and a gate flexible film 728. The data PCB 722 applies a data driving signal to the LCD panel 710. The gate PCB 724 applies a gate driving signal to the LCD panel 710. The data flexible circuit film 726 electrically connects the data PCB 722 to the LCD panel 710. The gate flexible circuit film 728 electrically connects the gate PCB 724 to the LCD panel 710. Each of the data and gate flexible circuit films 726 and 728 may be a tape carrier package (TCP) or a chip on film (COF).

The data flexible circuit film 726 is bent backwards so that the data PCB 722 is on a side surface or a rear surface of the receiving container 830. The gate flexible circuit film 728 is also bent backwards so that the gate PCB 724 is on the side surface or the rear surface of the receiving container 830. Alternatively, an auxiliary signal line (not shown) may be formed on the LCD panel 710 and the gate flexible circuit film 728 so that the gate PCB 724 may be omitted.

The LCD device 600 further includes an optical sheet 810 on a diffusion plate 220 of the backlight assembly 100. The optical sheet 810 guides the light that has passed through the diffusion plate 220, and improves optical characteristics of the light. The optical sheet 810 may include a bright enhancement film (BEF) that increases luminance of the light when viewed in a plan view of the backlight assembly 100. The optical sheet 810 may further include a diffusion sheet that diffuses the light that has passed through the diffusion plate 220 to provide uniform luminance of the light. Alternatively, the optical sheet 810 may further include various optical films.

Alternatively, the LCD device 600 may further include a top chassis (not shown) to fix the LCD panel 710. The top chassis (not shown) surrounds the sides of the LCD panel 710 that is combined with the receiving container 240 so that the LCD panel 710 is fixed on the backlight assembly 100.

According to the present invention, the auxiliary light sources are adjacent to corners of the main light source so that the luminance of the light generated from the corners of the backlight assembly is increased to provide uniform luminance of the backlight assembly, thereby improving the image display quality. In addition, each of the auxiliary light sources is connected in parallel to the diode to decrease the malfunction of the auxiliary light sources.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly comprising:
a main light source under a liquid crystal display panel that displays an image, the main light source generating a main light; and
an auxiliary light source under the liquid crystal display panel, the auxiliary light source generating an auxiliary light.

2. The backlight assembly of claim 1, further comprising a diffusion plate disposed on the main light source.

3. The backlight assembly of claim 2, wherein the auxiliary light source is disposed adjacent to a corner of the main light source.

4. The backlight assembly of claim 3, wherein a corner of the diffusion plate is chamfered.

5. The backlight assembly of claim 4, wherein the auxiliary light source is disposed adjacent to the chamfered corner of the diffusion plate.

6. The backlight assembly of claim 1, wherein the auxiliary light source is outside of an active layer corresponding to the main light source.

7. The backlight assembly of claim 1, wherein the auxiliary light source includes a light emitting diode that generates white light.

8. The backlight assembly of claim 1, wherein the auxiliary light source is disposed at each corner of the main light source.

9. The backlight assembly of claim 1, wherein the main light source comprises a flat fluorescent lamp, and a light emitting area of the main light source is substantially equal to an area of the liquid crystal display panel.

10. The backlight assembly of claim 1, wherein the main light source comprises a plurality of cold cathode fluorescent lamps that are arranged to be substantially parallel with one another.

11. The backlight assembly of claim 1, wherein the main light source comprises a plurality of external electrode fluorescent lamps that are electrically connected to one another, in parallel.

12. The backlight assembly of claim 1, further comprising an inverter that supplies an electric power to the main light source.

13. The backlight assembly of claim 12, wherein the auxiliary light source is electrically connected between the inverter and the main light source.

14. The backlight assembly of claim 13, wherein a plurality of auxiliary light sources are disposed under the liquid crystal display panel, and two auxiliary light sources are electrically connected to each other, in parallel.

15. The backlight assembly of claim 14, further comprising a plurality of diodes electrically connected in parallel to the auxiliary light sources, respectively.

16. A liquid crystal display device comprising:
a backlight assembly including a main light source and an auxiliary light source, wherein the main light source and the auxiliary light source generate light; and
a liquid crystal display panel that displays an image using the light generated from the backlight assembly.

17. The liquid crystal display device of claim 16, wherein the backlight assembly further comprises a diffusion plate disposed on the main light source, and the auxiliary light source is adjacent to a corner of the diffusion plate.

18. The liquid crystal display device of claim 17, wherein a corner of the diffusion plate is chamfered.

19. The liquid crystal display device of claim 18, wherein the auxiliary light source is disposed adjacent to the chamfered corner of the diffusion plate.

20. The liquid crystal display device of claim 16, wherein the auxiliary light source is outside of an active layer corresponding to the main light source.

21. The liquid crystal display device of claim 16, wherein the auxiliary light source comprises a light emitting diode that emits white light.

22. The liquid crystal display device of claim 16, wherein the main light source comprises a flat fluorescent lamp, and a light emitting area of the main light source is substantially equal to an area of the liquid crystal display panel.

23. The liquid crystal display device of claim 16, wherein the main light source comprises a plurality of cold cathode fluorescent lamps that are arranged to be substantially parallel with one another.

24. The liquid crystal display device of claim 16, wherein the main light source comprises a plurality of external electrode fluorescent lamps that are electrically connected to one another, in parallel.

25. The liquid crystal display device of claim 16, wherein the main light source comprises a first substrate and a second substrate that is combined with the first substrate to form a plurality of discharge spaces.

26. The liquid crystal display device of claim 25, wherein the first substrate has a quadrangular plate-like shape and is manufactured from glass.

27. The liquid crystal display device of claim 25, wherein the second substrate comprises a plurality of trapezoidal shapes, polygonal shapes, semicircular shapes, or quadrangular shapes that are connected to one another.

28. The liquid crystal display device of claim 25, wherein the second substrate comprises a plurality of discharge space portions, a plurality of space dividing portions and a sealing portion.

29. The liquid crystal display device of claim 28, wherein the discharge space portion are separated from a first substrate to form a discharge space.

30. The liquid crystal display device of claim 28, wherein the space dividing portion contacts the first substrate.

31. The liquid crystal display device of claim 28, wherein the space dividing portion is located between the discharge space portions.

32. The liquid crystal display device of claim 25, wherein the second substrate further includes connecting passages that facilitate a uniform pressure of the discharge gas in a discharge space.

33. The liquid crystal display device of claim 22, wherein the first substrate includes a reflecting layer disposed thereon, and a first fluorescent layer disposed upon the reflecting layer.

34. The liquid crystal display device of claim 33, wherein the second substrate includes a second fluorescent layer that is opposed to the first fluorescent layer in a discharge space.

35. The liquid crystal display device of claim 16, further comprising an inverter that supplies an electric power to the main light source.

36. The liquid crystal display device of claim 35, wherein the auxiliary light source is electrically connected between the inverter and the main light source.
